(19) United States
(12) Patent Application Publication
(10) Pub. No.: US 2026/0246801 A1
(43) Pub. Date: Aug. 20, 2026

(54) ENHANCED DETECTION OF VIOLATION CONDITIONS USING LARGE LANGUAGE MODELS

(71) Applicant: DIGITAL REASONING SYSTEMS, INC., FRANKLIN, TN (US)

(72) Inventors: Uday KAMATH, Franklin, TN (US); Theo HILL, Franklin, TN (US); Kevin KENNAN, Franklin, TN (US); Walter ANDREWS, Franklin, TN (US); Brandon CARL, Franklin, TN (US)

(21) Appl. No.: 19/558,601

(22) Filed: Mar. 6, 2026

Related U.S. Application Data
(63) Continuation of application No. PCT/US2024/047263, filed on Sep. 18, 2024.
(60) Provisional application No. 63/583,395, filed on Sep. 18, 2023.

(51) Int. Cl. H04L 9/40

(52) U.S. Cl. CPC H04L 63/1425; H04L 63/1441

(57) ABSTRACT

An example computer-implemented method includes receiving at least one alert from a conduct surveillance system, where the at least one alert represents a potential violation of a predetermined standard and where the conduct surveillance system generates alerts in response to analyzing electronic communications between persons; prompting a trained large language model (LLM) to generate an analysis of the at least one alert, where the analysis of the at least one alert comprises an explanation and a certainty score; and automatically actioning the at least one alert based on the certainty score.

### CROSS-REFERENCE TO RELATED APPLICATIONS

This application is a continuation of International Application No. PCT/US24/47263, filed on Sep. 18, 2024, and entitled “ENHANCED DETECTION OF VIOLATION CONDITIONS USING LARGE LANGUAGE MODELS,” which claims the benefit of, and priority to, U.S. provisional application No. 63/583,395, filed on Sep. 18, 2023, and entitled “ENHANCED DETECTION OF VIOLATION CONDITIONS USING LARGE LANGUAGE MODELS,” the disclosures of which are hereby expressly incorporated herein by reference in their entireties.

### BACKGROUND

The present disclosure generally relates to monitoring communications for activity that violates ethical, legal, or other standards of behavior and poses risk or harm to institutions or individuals. The need for detecting violations in the behavior of representatives of an institution has become increasingly important in the context of proactive compliance, for instance.

Systems for detecting violations can generate large numbers of alerts, sometimes hundreds or thousands of alerts each day. Often, many of the alerts are false positives, which require a human reviewer to identify the false positive and close the alert. Many other alerts may represent real violations, but can be low risk or low priority. These lower risk or lower priority alerts can also require significant amounts of time to review using human reviewers. Closing alerts can include a human reviewer providing a reason that the alert is being closed. This process of identifying and closing the alerts can be very time consuming for human reviewers. Among other needs, there exists a need for effective identification of activity that violates ethical, legal, or other standards of behavior and poses risk or harm to institutions or individuals from electronic communications. Furthermore, there exists a need for effective ways to improve the identification of violation conditions and effective ways to configure systems to identify violation conditions. It is with respect to these and other considerations that the various embodiments described below are presented.

### SUMMARY

Embodiments of the present disclosure are directed generally towards methods, systems, and computer-readable storage medium relating to, in some embodiments, an intuitive review and investigation tool designed to facilitate efficient and defensible reviews of electronic communications (e.g., messages) by analysts (sometimes referred to herein as “users”). In certain implementations, a large language model (LLM) can be used to automate the role of some analysts, creating reviews of electronic communications that can be analyzed by users to determine whether the large language model review is correct. The reviews of electronic communications can include explanations of why the communications are (or are not) false positive alerts. Optionally, the LLM can be configured to output a certainty score that represents the likelihood that the communications are (or are not) false positives. Optionally, the certainty score (or an additional certainty score) can represents the risk or severity of the violation represented by the alert. It should be understood that the certainty score can include more than one number or value, and is not limited to a single “score.” Actioning can be performed on communications at the hit, alert, and/or message level to illustrate progress of reviewed communications and streamline business processes. Optionally, the system can be configured to close one or more of the alerts. For example, the LLM can perform a first-line review of the alerts and corresponding electronic communications, determine whether alerts are false positives, and action alerts that are determined to be false positives. Optionally, the actioning can include auto-closing the alerts, preventing an alert from being triggered, preventing the alert from being shown to the user, and/or taking other actions described herein based on a certainty score or certainty scores output by the LLM. Optionally, determining whether alerts are false positives can include generating a certainty score. The certainty score can represent the likelihood that the alert is (or is not) a false positive. Auto-closing alerts can reduce the burden on human analysts. Embodiments of the present disclosure further include methods and systems for validating the performance LLM that is performing the first-line review. Embodiments of the present disclosure further include user interfaces for configuring the LLM, training the LLM, and reviewing alerts that are reviewed by the LLM.

In some aspects, implementations of the present disclosure include a computer-implemented method, including: receiving at least one alert from a conduct surveillance system, wherein the at least one alert represents a potential violation of a predetermined standard and wherein the conduct surveillance system generates alerts in response to analyzing electronic communications between persons; prompting a trained large language model (LLM) to generate an analysis of the at least one alert, wherein the analysis of the at least one alert includes an explanation and a certainty score; and automatically actioning the at least one alert based on the certainty score.

In some aspects, implementations of the present disclosure include a computer-implemented method, wherein the explanation includes one or more factors considered during the analysis and reasoning associated with the analysis.

In some aspects, implementations of the present disclosure include a computer-implemented method, wherein the trained large language model is configured to use chain of thought (CoT) reasoning to generate the analysis of the at least one alert.

In some aspects, implementations of the present disclosure include a computer-implemented method, wherein the trained large language model is configured to use self-verification process to generate the analysis of the at least one alert.

In some aspects, implementations of the present disclosure include a computer-implemented method, further including displaying the at least one alert and the analysis of the at least one alert.

In some aspects, implementations of the present disclosure include a computer-implemented method, wherein the at least one alert is based on a communication, and the computer-implemented method further includes displaying the communication and the analysis of the at least one alert.

In some aspects, implementations of the present disclosure include a computer-implemented method, wherein prompting the trained large language model includes inputting a prompt using a prompting language.

In some aspects, implementations of the present disclosure include a computer-implemented method, wherein prompting the trained large language model includes inputting a role prompt.

In some aspects, implementations of the present disclosure include a computer-implemented method, wherein prompting the trained large language model includes inputting a prompt including a plurality of questions.

In some aspects, implementations of the present disclosure include a computer-implemented method, wherein prompting the trained large language model includes completing a template including a plurality of questions.

In some aspects, implementations of the present disclosure include a computer-implemented method, further including configuring the trained large language model to generate an analysis of the at least one alert using a user interface.

In some aspects, implementations of the present disclosure include a computer-implemented method, wherein the trained large language model is configured to provide a deterministic output.

In some aspects, implementations of the present disclosure include a computer-implemented method, further including applying a filter to the at least one alert before prompting the trained large language model to generate the analysis of the at least one alert, the filter being configured to identify and disregard obvious false positive violations of the predetermined standard.

In some aspects, implementations of the present disclosure include a computer-implemented method, wherein the certainty score represents a probability of the at least one alert represents a true violation of the predetermined standard.

In some aspects, implementations of the present disclosure include a computer-implemented method, wherein automatically actioning the at least one alert includes comparing the certainty score to one or more thresholds.

In some aspects, implementations of the present disclosure include a computer-implemented method, further including adjusting the one or more thresholds based on user input.

In some aspects, implementations of the present disclosure include a computer-implemented method, wherein automatically actioning the at least one alert includes closing the at least one alert or escalating the at least one alert for further analysis.

In some aspects, implementations of the present disclosure include a system, including: at least one processor; at least one memory storing computer readable instructions configured to cause the at least one processor to perform functions for creating and/or evaluating models, scenarios, lexicons, and/or policies with large language models (LLMs), wherein the functions include: receiving at least one alert from a conduct surveillance system, wherein the at least one alert represents a potential violation of a predetermined standard and wherein the conduct surveillance system generates alerts in response to analyzing electronic communications between persons; prompting a trained large language model (LLM) to generate an analysis of the at least one alert, wherein the analysis of the at least one alert includes an explanation and a certainty score; and automatically actioning the at least one alert based on the certainty score.

In some aspects, implementations of the present disclosure include a system, wherein the explanation includes one or more factors considered during the analysis and reasoning associated with the analysis.

In some aspects, implementations of the present disclosure include a system, wherein the trained large language model is configured to use chain of thought (CoT) reasoning to generate the analysis of the at least one alert.

In some aspects, implementations of the present disclosure include a system, wherein the trained large language model is configured to use self-verification process to generate the analysis of the at least one alert.

In some aspects, implementations of the present disclosure include a system, wherein the functions further include displaying the at least one alert and the analysis of the at least one alert.

In some aspects, implementations of the present disclosure include a system, wherein the at least one alert is based on a communication, and the functions further include displaying the communication and the analysis of the at least one alert.

In some aspects, implementations of the present disclosure include a system, wherein prompting the trained large language model includes inputting a prompt using a prompting language.

In some aspects, implementations of the present disclosure include a system, wherein prompting the trained large language model includes inputting a role prompt.

In some aspects, implementations of the present disclosure include a system, wherein prompting the trained large language model includes inputting a prompt including a plurality of questions.

In some aspects, implementations of the present disclosure include a system, wherein prompting the trained large language model includes completing a template including a plurality of questions.

In some aspects, implementations of the present disclosure include a system, wherein the functions further include configuring the trained large language model to generate an analysis of the at least one alert using a user interface.

In some aspects, implementations of the present disclosure include a system, wherein the trained large language model is configured to provide a deterministic output.

In some aspects, implementations of the present disclosure include a system, wherein the functions further include applying a filter to the at least one alert before prompting the trained large language model to generate the analysis of the at least one alert, the filter being configured to identify and disregard obvious false positive violations of the predetermined standard.

In some aspects, implementations of the present disclosure include a system, wherein the certainty score represents a probability of the at least one alert represents a true violation of the predetermined standard.

In some aspects, implementations of the present disclosure include a system, wherein automatically actioning the at least one alert includes comparing the certainty score to one or more thresholds.

In some aspects, implementations of the present disclosure include a system, wherein the functions further include adjusting the one or more thresholds based on user input.

In some aspects, implementations of the present disclosure include a system, wherein automatically actioning the at least one alert includes closing the at least one alert or escalating the at least one alert for further analysis.

In some aspects, implementations of the present disclosure include a non-transitory computer-readable medium storing instructions which, when executed by at least one processor of a computer, perform functions that include: receiving at least one alert from a conduct surveillance system, wherein the at least one alert represents a potential violation of a predetermined standard and wherein the conduct surveillance system generates alerts in response to analyzing electronic communications between persons; prompting a trained large language model (LLM) to generate an analysis of the at least one alert, wherein the analysis of the at least one alert includes an explanation and a certainty score; and automatically actioning the at least one alert based on the certainty score.

In some aspects, implementations of the present disclosure include a non-transitory computer-readable medium, wherein the explanation includes one or more factors considered during the analysis and reasoning associated with the analysis.

In some aspects, implementations of the present disclosure include a non-transitory computer-readable medium, wherein the trained large language model is configured to use chain of thought (CoT) reasoning to generate the analysis of the at least one alert.

In some aspects, implementations of the present disclosure include a non-transitory computer-readable medium, wherein the trained large language model is configured to use self-verification process to generate the analysis of the at least one alert.

In some aspects, implementations of the present disclosure include a non-transitory computer-readable medium, wherein the functions further include displaying the at least one alert and the analysis of the at least one alert.

In some aspects, implementations of the present disclosure include a non-transitory computer-readable medium, wherein the at least one alert is based on a communication, and the functions further include displaying the communication and the analysis of the at least one alert.

In some aspects, implementations of the present disclosure include a non-transitory computer-readable medium, wherein prompting the trained large language model includes inputting a prompt using a prompting language.

In some aspects, implementations of the present disclosure include a non-transitory computer-readable medium, wherein prompting the trained large language model includes inputting a role prompt.

In some aspects, implementations of the present disclosure include a non-transitory computer-readable medium, wherein prompting the trained large language model includes inputting a prompt including a plurality of questions.

In some aspects, implementations of the present disclosure include a non-transitory computer-readable medium, wherein prompting the trained large language model includes completing a template including a plurality of questions.

In some aspects, implementations of the present disclosure include a non-transitory computer-readable medium, wherein the functions further include configuring the trained large language model to generate an analysis of the at least one alert using a user interface.

In some aspects, implementations of the present disclosure include a non-transitory computer-readable medium, wherein the trained large language model is configured to provide a deterministic output.

In some aspects, implementations of the present disclosure include a non-transitory computer-readable medium, wherein the functions further include applying a filter to the at least one alert before prompting the trained large language model to generate the analysis of the at least one alert, the filter being configured to identify and disregard obvious false positive violations of the predetermined standard.

In some aspects, implementations of the present disclosure include a non-transitory computer-readable medium, wherein the certainty score represents a probability of the at least one alert represents a true violation of the predetermined standard.

In some aspects, implementations of the present disclosure include a non-transitory computer-readable medium, wherein automatically actioning the at least one alert includes comparing the certainty score to one or more thresholds.

In some aspects, implementations of the present disclosure include a non-transitory computer-readable medium, wherein the functions further include adjusting the one or more thresholds based on user input.

In some aspects, implementations of the present disclosure include a non-transitory computer-readable medium, wherein automatically actioning the at least one alert includes closing the at least one alert or escalating the at least one alert for further analysis.

In some aspects, implementations of the present disclosure include a computer-implemented method, including: receiving at least one alert from a conduct surveillance system, wherein the at least one alert represents a potential violation of a predetermined standard and wherein the conduct surveillance system generates alerts in response to analyzing electronic communications between persons; dynamically routing the at least one alert to one or more of a plurality of models, each of the plurality of models being configured to identify a respective type of false positive violation of the predetermined standard; analyzing, using the one or more of the plurality of models, the at least one alert; and automatically actioning the at least one alert based on the analysis of the at least one alert.

In some aspects, implementations of the present disclosure include a computer-implemented method, wherein automatically actioning the at least one alert includes closing the at least one alert or escalating the at least one alert for further analysis.

In some aspects, implementations of the present disclosure include a computer-implemented method, wherein the plurality of models include a trained large language model (LLM) configured to generate an analysis of the at least one alert.

In some aspects, implementations of the present disclosure include a computer-implemented method, wherein the trained large language model is configured to use chain of thought (CoT) reasoning to generate the analysis of the at least one alert.

In some aspects, implementations of the present disclosure include a computer-implemented method, wherein the trained large language model is configured to use self-verification process to generate the analysis of the at least one alert.

In some aspects, implementations of the present disclosure include a system, including: at least one processor; at least one memory storing computer readable instructions configured to cause the at least one processor to perform functions for creating and/or evaluating models, scenarios, lexicons, and/or policies with large language models (LLMs), wherein the functions include: receiving at least one alert from a conduct surveillance system, wherein the at least one alert represents a potential violation of a predetermined standard and wherein the conduct surveillance system generates alerts in response to analyzing electronic communications between persons; dynamically routing the at least one alert to one or more of a plurality of models, each of the plurality of models being configured to identify a respective type of false positive violation of the predetermined standard; analyzing, using the one or more of the plurality of models, the at least one alert; and automatically actioning the at least one alert based on the analysis of the at least one alert.

In some aspects, implementations of the present disclosure include a system, wherein automatically actioning the at least one alert includes closing the at least one alert or escalating the at least one alert for further analysis.

In some aspects, implementations of the present disclosure include a system, wherein the plurality of models include a trained large language model (LLM) configured to generate an analysis of the at least one alert.

In some aspects, implementations of the present disclosure include a system, wherein the trained large language model is configured to use chain of thought (CoT) reasoning to generate the analysis of the at least one alert.

In some aspects, implementations of the present disclosure include a system, wherein the trained large language model is configured to use self-verification process to generate the analysis of the at least one alert.

In some aspects, implementations of the present disclosure include a non-transitory computer-readable medium storing instructions which, when executed by at least one processor of a computer, perform functions that include: receiving at least one alert from a conduct surveillance system, wherein the at least one alert represents a potential violation of a predetermined standard and wherein the conduct surveillance system generates alerts in response to analyzing electronic communications between persons; dynamically routing the at least one alert to one or more of a plurality of models, each of the plurality of models being configured to identify a respective type of false positive violation of the predetermined standard; analyzing, using the one or more of the plurality of models, the at least one alert; and automatically actioning the at least one alert based on the analysis of the at least one alert.

In some aspects, implementations of the present disclosure include a non-transitory computer-readable medium, wherein automatically actioning the at least one alert includes closing the at least one alert or escalating the at least one alert for further analysis.

In some aspects, implementations of the present disclosure include a non-transitory computer-readable medium, wherein the plurality of models include a trained large language model (LLM) configured to generate an analysis of the at least one alert.

In some aspects, implementations of the present disclosure include a non-transitory computer-readable medium, wherein the trained large language model is configured to use chain of thought (CoT) reasoning to generate the analysis of the at least one alert.

In some aspects, implementations of the present disclosure include a non-transitory computer-readable medium, wherein the trained large language model is configured to use self-verification process to generate the analysis of the at least one alert.

A streamlined actioning workflow can allow users to easily close alerts and add relevant context (for example, person of interest and comments) to elevated alerts requiring further review. Alerts assigned to a user can be accessed from a user dashboard, where the user can also see the total messages awaiting review.

The following provides a non-limiting discussion of some example implementations of various aspects of the present disclosure. Some aspects and embodiments disclosed herein may be utilized for providing advantages and benefits in the area of communication surveillance for regulatory compliance. Some implementations can process all communications, including electronic forms of communications such as instant messaging (or “chat”), email, voice, and/or social network messaging to connect and monitor an organization's employee communications for regulatory and corporate compliance purposes. Some embodiments of the present disclosure unify detection, user interfaces, behavioral models, and policies across all communication data sources, and can provide tools for compliance analysts in furtherance of these functions and objectives. Some implementations can proactively analyze users'actions to identify breaches such as unauthorized activities that are against applicable policies, laws, or are unethical, through the use of natural language processing (NLP) models. The use of these models can enable understanding content of communications and map signals to behavioral profiles in order to locate high-risk individuals.

Other aspects and features according to the example embodiments of the present disclosure will become apparent to those of ordinary skill in the art, upon reviewing the following detailed description in conjunction with the accompanying figures.

### BRIEF DESCRIPTION OF THE DRAWINGS

Reference will now be made to the accompanying drawings, which are not necessarily drawn to scale.

FIG. 1A illustrates a method of analyzing and/or auto-actioning alerts using a trained large language model (LLM), according to embodiments of the present disclosure.

FIG. 1B illustrates a method of dynamically routing alerts to machine learning models for analysis and/or auto-actioning, according to embodiments of the present disclosure.

FIG. 2A illustrates a prompt template that can be used in the system illustrated in FIG. 2B. FIG. 2B illustrates a block diagram of a system for displaying auto-reviewed alerts to a user for review, according to embodiments of the present disclosure.

FIG. 3 illustrates an example user interface for reviewing communications with an LLM analysis of the communications, according to embodiments of the present disclosure.

FIG. 4 illustrates an example user interface for reviewing communications with an LLM analysis of the communications, according to embodiments of the present disclosure.

FIG. 5 illustrates an example framework for actioning alerts and performing quality control on actioned alerts, according to embodiments of the present disclosure.

FIG. 6 illustrates an example method of validating results of automatic review of alerts, according to embodiments of the present disclosure.

FIG. 7 illustrates an example method of performing quality control on automatically auto-closed alerts, according to embodiments of the present disclosure.

FIG. 8 illustrates an example prompt/question bank for example policies, according to embodiments of the present disclosure.

FIG. 9 illustrates an example computing device.

FIG. 10 illustrates an example system for actioning alerts using one or more large language models, according to embodiments of the present disclosure.

FIG. 11 illustrates an example system with three levels of review, according to embodiments of the present disclosure.

### DETAILED DESCRIPTION

Although example embodiments of the present disclosure are explained in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an” and “the” include plural referents unless the context clearly dictates otherwise.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

### Definitions

The following discussion provides some descriptions and non-limiting definitions, and related contexts, for terminology and concepts used in relation to various aspects and embodiments of the present disclosure.

An “event” can be considered any object with a fixed time, and an event can be observable data that happens at a point in time, for example an email, a badge swipe, a trade (e.g., trade of a financial asset), or a phone call.

A “property” relates to an item within an event that can be uniquely identified, for example metadata.

A “communication” or “electronic communication” can be any event with language content, for example email, chat, a document, social media, or a phone call. An electronic communication may also include, for example, audio, SMS, and/or video. A communication may additionally or alternatively be referred to herein as, or with respect to, a “comm” (or “comms”), message, container, report, or data payload.

A “metric” can be a weighted combination of factors to identify patterns and trends (e.g., a number-based value to represent behavior or intent from a communication). Examples of metrics include sentiment, flight risk, risk indicator, and responsiveness score. A metric may additionally or alternatively be referred to herein as, or with respect to, a score, measurement, or rank.

A “post” can be an identifier's contribution within a communication, for example a single email within a thread, a single chat post, a continuous burst of communication from an individual, or a single social media post. A post can be considered as an individual's contribution to a communication.

A “conversation” can be a group of semantically related posts, for example the entirety of an email with replies, a thread, or alternative a started and stopped topic, a time-bound topic, and/or a post with the other post (replies). Several posts can make up a conversation within a communication.

A “signal” can be an observation tied to a specific event that is identifiable, for example rumor language, wall crossing, or language of interest.

A “policy” can be a scenario applied to a population with a defined workflow. A policy may be, for instance, how a business chooses to handle specific situations, for example as it may relate to ongoing deal monitoring, disclaimer adherence, and/or anti money laundering (AML) monitoring. In some embodiments a policy can be comprised of three items: a scenario as a combination of signals and metrics (as an example of usage, using NLP signals and metrics to discover intellectual property (IP) theft language or behaviors); a population, as the target population over which to look for the scenario (e.g., sales team(s), department(s), or group(s) of persons); and workflow, as actions taken when a scenario triggers over a population (e.g., alert generation).

An “alert” can represent a potential violation of a predetermined standard. It should be understood that, as used in the present disclosure, an “alert” or “alerts” can be displayed to the user, or can be not displayed to the user. In some embodiments, an “alert” or “alerts” are processed (i.e., “actioned”) by the systems and methods described herein without being displayed to a user and/or without any action being taken by a user. Alternatively or additionally, the alert can be displayed to the user in some embodiments, and the alert can indicate to a user that a policy match has occurred which requires action (sometimes referred to herein with respect to “actioning” an alert), for example a scenario match. A signal that requires review can be considered an alert. As an example, an indication of intellectual property theft may be found in a chat post with language that matches the scenario, on a population that needs to be reviewed.

A “manual alert” can be an alert added to a communication from a user, not generated from the system. A manual alert may be used, for example, when a user needs to add an alert to language or other factors for further review.

A “hit” can be an exact signal that applies to a policy on events, for example an occurrence of the language “I'm taking clients with me when I leave”, a behavior pattern change, and/or a metric change.

A “review” can be the act of a user assigning actions on hits, alerts, or communications.

A “tag” can be a label attached to a communication for the purpose of identification or to give other information, for example a new feature set that will enable many workflow practices.

A “knowledge graph” can be a representation of all of the signals, entities, topics, and relationships in a data set in storage. Knowledge graphs can communications, some of which may contain alerts for a given policy. Other related terms may include a “knowledge base.” In some embodiments, a knowledge graph can be a unified knowledge renresent.alion.

A “personal identifier” can be any structured field that can be used to define a reference or entity, for example “jeb@jebbush.com”, “@CMcK”, “EnronUser 1234”, or “(555)336-2700” (i.e., a personal identifier can include email, a chat handle, or a phone number). As used herein, a hit may additionally or alternatively be referred to herein as, or with respect to, an “entity ID”.

A “mention” can be any descriptive string that is able to be referenced and/or extracted, for example “He/Him”, “The Big Blue”, “Enron”, or “John Smith”. Other related terms may include “local coreference.”

An “entity” can be an individual, object, and/or property IRL, and can have multiple identifiers or references, for example John Smith, IBM, or Enron. Other related terms may include profile, participant, actor, and/or resolved entity.

A “relationship” can be a connection between two or more identifiers or entities, for example “works in” department, person-to-person, person-to-department, and/or company-to-company. Other related terms may include connections via a network graph.

The following discussion includes some descriptions and non-limiting definitions, and related contexts, for terminology and concepts that may particularly relate to workflows in accordance to one or more embodiments of the present disclosure.

A “smart queue” can be a saved set of search modifiers with an owner and defined time, for example, a daily bribery queue, an action pending queue, an escalation queue, or any shared/synced list. As used herein, a smart queue may additionally or alternatively be referred to herein as, or with respect to an action pending queue, analyst queue, or scheduled search.

A “saved search” can be a saved set of search modifiers with no owner, for example a monthly QA check, an investigation search, or an irregularly used search. As used herein, a saved search may additionally or alternatively be referred to herein as, or with respect to a search copy or a bookmark.

The following discussion includes some descriptions and non-limiting definitions, and related contexts, for terminology and concepts that can relate to a graphical user interface (and associated example views as output to a user) that can be used by a user to interact with, visualize, and perform various functionalities in accordance to one or more embodiments of the present disclosure.

A “sidebar” can be a global placeholder for navigation and branding. “Content” as used herein refers to a location of a user interface where primary content will be displayed.

An “aside”, is a location for supportive components that affect the content or provide additional context. An aside can be a column of components that support, define, or manipulate the content area.

A “visual view” can include a chart, graph, or data representation that is beyond simple text, for example communications (“comms”) over time, alters daily, queue progress, and/or relationship metric(s). As used herein, visual views may additionally or alternatively be referred to herein as, or with respect to charts or graphs.

A “profile” can be a set of visuals filtered by an identifier or entity, for example by a specific person's name, behavior analytics, an organization's name, or QA department. As used herein, profiles may additionally or alternatively be referred to herein as, or with respect to relationship(s) or behavior analytics.

Smart queues can enable teams to work to accelerate “knowledge tasks”. Signals that require review (i.e., alerts), comprise monitoring. These can be from external systems. Knowledge tasks can provide feedback via a “learning loop” into models.

A profile view can provide insights such as behavioral insights to, for instance, an entity (here, a particular person). The profile can include a unified timeline with hits, and communications. Also, profiles can provide aggregates of/into entities, metrics, visuals, events, and relationships. An aside can be a column of components that support, define, or manipulate the content area.

An “alert” can be the manifestation of a policy on events, and a “hit” (or “alert hit”) can be the exact signal that applies to a policy on events. An “action” can be the label that is applied to: a single hit; all hits under an alert; or all hits on a message. A “list card” can be an object that contains a summary of the content of a comm in the “list view”, which can be a list of events with communications that may have an alert.

A “metric” can be a weighted combination of factors to identify patterns and trends. A “tab” can be an additional view that can display content related to a current view, for example sibling content.

The following discussion includes some descriptions and non-limiting definitions, and related contexts, for terminology and concepts that may particularly relate to machine learning models and the training of machine learning models, in accordance with one or more embodiments of the present disclosure.

A “hit” can be an exact signal that applies to a policy on events, for example an occurrence of the language “I'm taking clients with me when I leave”, a behavior pattern change, and/or a metric change.

A “pre-trained model” can be a model that performs a task but requires tuning (e.g., supervision and/or other interaction by an analyst or developer) before production. An “out of the box model” can be a model that benefits from, but does not require, tuning before use in production. Pre-trained models and out of the box models can be part of the building blocks for a policy. As used herein, a pre-trained model may additionally or alternatively be referred to herein as, or with respect to, “KI engines” or “models”.

In some embodiments, the present disclosure can provide for implementing analytics using “supervised” machine learning techniques (herein also referred to as “supervised learning”). Supervised mathematical models can encode a variety of different data aspects which can be used to reconstruct a model at run-time. The aspects utilized by these models may be determined by analysts and/or developers, for example, and may be fixed at model training time. Models can be retrained at any time, but retraining may be done more infrequently once models reach certain levels of accuracy.

### Description of Example Embodiments of Present Disclosure

A detailed description of various aspects of the present disclosure, in accordance with various example embodiments, will now be provided with reference to the accompanying drawings. The drawings form a part hereof and show, by way of illustration, specific embodiments and examples.

The following provides a non-limiting discussion of some example implementations of various aspects of the present disclosure.

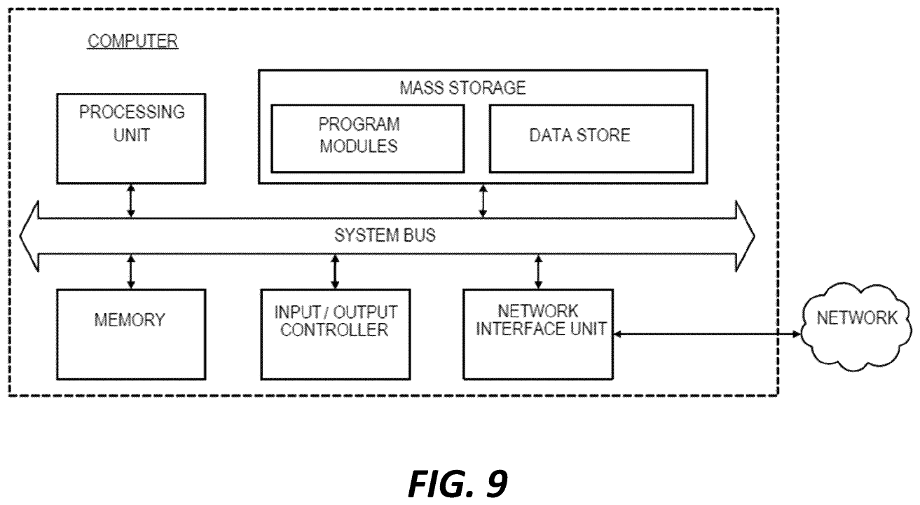

In some embodiments, the present disclosure is directed to a system for indicating to a user when a policy match has occurred which requires action by the user. The system can include a processor and a memory configured to cause the processor to perform functions for creating and/or evaluating models, scenarios, lexicons, and/or policies. As a non-limiting example, the processor and memory can be part of the general computing system illustrated in FIG. 9.

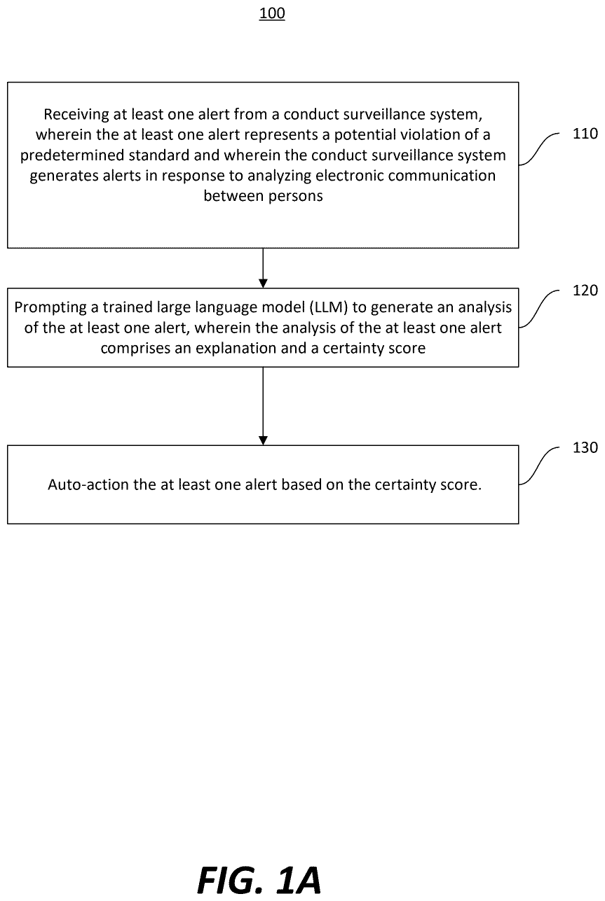

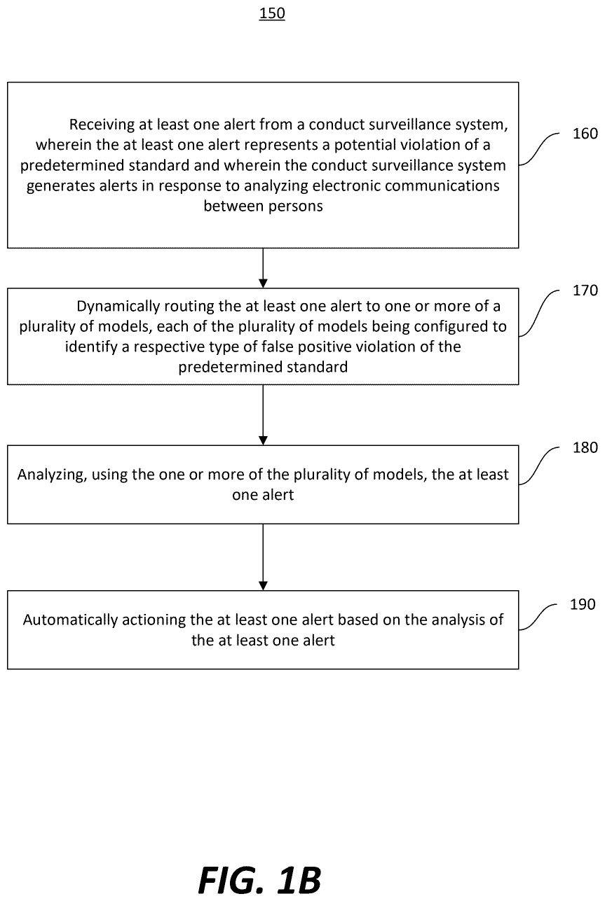

Embodiments of the present disclosure can implement the method illustrated in FIG. 1A The instructions stored on the memory can include instructions to receive data associated with text data, model training, lexicons, scenarios and/or policies. Creating and/or evaluating models can include creating a scenario based on the models, lexicons, and non-language features. It should be understood that the scenario can be based on any combination of models, lexicons, and non-language features. As a non-limiting example, the scenario can be based on a single model, but multiple lexicons and multiple non-language features.

As described herein, the model can correspond to a machine learning model. In some embodiments, the machine learning model is a machine learning classifier that is configured to classify text. Additionally, in some embodiments, the model training can include training models for analysis of text data from one or more electronic communications between at least two persons.

The term “artificial intelligence” is defined herein to include any technique that enables one or more computing devices or comping systems (i.e., a machine) to mimic human intelligence. Artificial intelligence (AI) includes, but is not limited to, knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve B ayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders. The term “deep learning” is defined herein to be a subset of machine learning that that enables a machine to automatically discover representations needed for feature detection, prediction, classification, etc. using layers of processing. Deep learning techniques include, but are not limited to, artificial neural network or multilayer perceptron (MLP).

Machine learning models include supervised, semi-supervised, and unsupervised learning models. In a supervised learning model, the model learns a function that maps an input (also known as feature or features) to an output (also known as target or targets) during training with a labeled data set (or dataset). In an unsupervised learning model, the model learns patterns (e.g., structure, distribution, etc.) within an unlabeled data set. In a semi-supervised model, the model learns a function that maps an input (also known as feature or features) to an output (also known as target or target) during training with both labeled and unlabeled data.

Deep learning models, including LLMs, may include artificial neural networks. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as input layer, output layer, and optionally one or more hidden layers. An ANN having hidden layers can be referred to as deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanH, or rectified linear unit (ReLU) function), and provide an output in accordance with the activation function. Additionally, each node is associated with a respective weight. ANNs are trained with a dataset to maximize or minimize an objective function. In some embodiments, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include, but are not limited to, backpropagation.

The present disclosure contemplates the machine learning training techniques known in the art can be applied to the data disclosed in the present disclosure for model training. For example, in some embodiments, the model training can include evaluating the model against established datasets. As another example, the model training can be based on a user input, for example a user input that labels the data.

The system can be configured to create one or more policies mapping to the scenario and a population. In embodiments with more than one scenario and/or more than one policy, it should be understood that any number of scenarios and/or policies can be mapped to one another. As non-limiting examples, the system can be configured to map multiple scenarios to multiple policies, or multiple scenarios to the same policy or policies.

When the system receives an alert that a policy match occurs, the system can trigger an alert indicating, to a user, that a policy match has occurred which requires action. As described above, in some embodiments alerts are not shown to the user. For example, in some embodiments the decision to show an alert to the user can be based on the review performed by the system. Optionally, the system can determine to show the alert to the user based on the certainty score described herein, and the user can then be prompted to review the alert. As a non-limiting example, if the certainty score is below a certain threshold, the system can display the alert to the user and/or prompt the user to perform a review of the alert. The policy can correspond to actions that violate at least one of a combination of signals and metrics, a population, and workflow (referred to herein as a “violation”)

Additionally, the present disclosure contemplates that the alerts can be reviewed by the user or by a machine learning model. This review can include determining whether the alerts correspond to an actual violation, and can be used to change the scenario, or change any of the parts of the scenario (e.g. models, lexicons, and non-language features).

In some embodiments of the present disclosure, a user can review the data and perform an interaction using a user interface (e.g., a graphical user interface that is part of or operably connected to the computer system illustrated in FIG. 9). The action can include review and interaction by a user via a user interface, which is optionally part of the computing device in FIG. 9. As a non-limiting example, in some embodiments, the system can provide the alert to the user through the user interface, and then the user can confirm or deny the accuracy of the alert using the user interface. Based on the user input, the system can determine whether the alert was a true positive, true negative, false positive, or false negative. The system can use the information about the alerts, including whether the alert was a true positive, true negative, false positive, or false negative, as an input into the system to improve the operation of the system. This can be referred to as “feedback.” The present disclosure contemplates that the feedback can be an input into the machine learning model to improve the model training (e.g., the information about the alerts is “fed back” into the model to train the model further). Alternatively or additionally, the present disclosure contemplates that the feedback can be used to change other parameters within the scenario. For example, the feedback can be used to adjust the lexicon or non-language features of the scenario. This can include adding or removing terms from the lexicon, or adding/removing non-language features from the scenario.

As a non-limiting example, a scenario has a pre-trained machine learning model, a target lexicon of regular expressions and text, and a target set of non-language features that includes metadata. In this example, the scenario can be configured to identify communications that correspond to the machine learning model and lexicon, where the metadata shows that the communication is from a time span of the previous two years. The system can then produce alerts by determining whether each of the communications in the dataset is a policy match with the scenario. The user can review the communications that are a policy match with the scenario, and determine whether each communication is a violation, and input those results into the system. Then, based on those results, the system can be configured to change the scenario to improve the effectiveness of the scenario. This can include maximizing or improving certain measures of accuracy such as the ROC curve described herein, the true positive rate, precision, recall, or confusion matrix. As a non-limiting example, this can include changing the scenario to target metadata in a shorter timeframe, e.g., by changing it from two years to one year. The system and/or the user can then use one or more of the measures of accuracy (e.g., the true positive rate) to see if the measure of accuracy has improved after changing the scenario. By monitoring the accuracy of the scenario as the scenario is changed, it is possible to tune the scenario to improve the measures of accuracy. Again, these are merely non-limiting examples of techniques for measuring the error rate, and it will be understood to one of skill in the art that any techniques for measuring error rate that are known in the art can be used in combination with the system and methods disclosed herein.

Embodiments of the present disclosure can also include computer implemented methods for configuring a computer system to detect violations in a target dataset.

With reference to FIG. 1A, an example computer-implemented method 100 for actioning alerts using large language models (LLMs) is shown.

At step 110, the computer-implemented method 100 includes receiving at least one alert from a conduct surveillance system. As used herein, a “conduct surveillance” system refers to any system for performing surveillance of any kind of electronic communications, voice communications, and/or other supervision systems that can record conduct of one or more people. The alert can represent a potential violation of a predetermined standard. The conduct surveillance system generates the alerts in response to an electronic communication between persons matching a violation of a predetermined policy, where the predetermined policy comprises a scenario, a target population, and a workflow.

At step 120, the computer-implemented method 100 includes prompting a trained large language model (LLM) to generate an analysis of the at least one alert. Large language models (LLMs) are a type of AI model that uses a large dataset to process input data and/or generate/predict new output data. LLMs can be types of deep learning-based language models using artificial neural networks that are pre-trained to generate text.

Optionally, a filter is used to filter the alerts before the LLM is prompted at step 120. The filter can be configured to identify and/or disregard obvious false positive violations of the predetermined standard so that they can be de-prioritized and/or excluded from review by the LLM.

Optionally, the analysis of the alert includes a certainty score. Prompting the trained large language model can include inputting a prompt using a prompting language. As used herein, a prompting language is a structured format for entering prompts into a large language model.

Optionally, the analysis of the alert includes an explanation. The explanation can include factors considered during the analysis and/or reasoning performed during the analysis. For example, chain-of-thought reasoning can be used to perform the analysis (e.g., by multiple prompts) and the intermediate reasoning steps can be part of the reasoning and/or factors considered during the analysis. Chain of thought (CoT) reasoning is a process used in problem-solving and decision-making where an AI model (e.g. an LLM) breaks down a complex problem into smaller, more manageable steps. This involves a sequence of thoughts or a logical progression of ideas that are interconnected, leading from an initial problem to a final solution. For example, when a model is asked a complex question, instead of jumping to an answer, it may use chain of thought reasoning to generate a sequence of logical steps. This helps in reaching more accurate or reliable conclusions. This disclosure contemplates that AI models such as LLMs can be trained to use CoT, for example by training the model on datasets where the prompts are explicitly designed to encourage step-by-step reasoning. Such prompts may instruct the model to “explain your reasoning” or “think through the problem step by step.” Additionally, the model can optionally be fine-tuned on specific datasets where the examples include detailed reasoning steps rather than just final answers. This helps the model learn to generate intermediate steps in a logical sequence. Additionally, the model may optionally be exposed to data where human annotators have broken down problems into steps during training, allowing the model to learn this structured reasoning process. Additionally, the model can optionally be shown a few examples of chain of thought reasoning before being asked to generate its own reasoning process. This is done using in-context learning, where the model is primed with examples that demonstrate the desired behavior. Additional examples of reasoning/analysis are described with reference to Examples 1 and 2, herein.

Alternatively or additionally a self—verification process can be used to validate the reasoning/analysis (e.g., using a test-queue to verify model performance, as described in Example 1). As used herein, self-verification refers to the processes by which a system checks and confirms the accuracy or consistency of its own outputs or internal states. For instance, an AI model such as an LLM may have built-in checks to verify that its predictions align with known data or past performance.

Alternatively or additionally, the certainty score can generated based on a risk scoring analysis performed by the LLM. Optionally, the certainty score can include a risk score, or can be based on a risk score. As a non-limiting example, risk scoring can include prompting the LLM to determine the magnitude of the risk (e.g., the severity of a potential violation) and/or prompting the LLM to determine the probability of the risk. The magnitude of the risk and the probability of the risk can be used to determine a risk score (e.g., by multiplying the magnitude of the risk by the probability of the risk).

Optionally, the LLM can be a deterministic LLM. As used herein, a deterministic LLM is an LLM that provides the same response to the same prompt, repeatedly. Optionally, the deterministic LLM can be used in combination with the prompting language to repeatably provide the LLM model with queries that generate repeatable outputs.

Optionally, the prompt can be a role prompt. As used herein, a role prompt can be a prompt that instructs the LLM to respond from the perspective of a specific role. For example, an LLM can be prompted to respond from the perspective of a fraud investigator, compliance officer,

Optionally, the prompt can include multiple prompts and/or multiple intermediate steps, including multiple questions and/or statements. Different types of multiple-prompt methods can be used. As an example, chain of thought reasoning can be used, where a single prompt can be implemented using intermediate steps that lead to a final output. As another example, self-verification can be used, where an LLM is configured to check an initial prompt output for accuracy/consistency. In self-verification, if initial prompt output is incorrect, then the LLM can be configured to generate a second response to correct the final output to be correct. As yet another example, multi-step prompting can be used, where an LLM is configured to implement a single task as multiple successive prompts and responses that yield a final output. It should be understood that references to “prompts” and/or “prompting” can optionally refer to any/all of these techniques, alone or in combination. For example, as explained herein, different LLMs and/or different types of prompts can be used/configured to analyze different types of alerts in various implementations of the present disclosure.

Alternatively or additionally, the LLM can be configured using a user interface. As non-limiting examples, the LLM can be configured to be deterministic or non-deterministic (for example by changing the “temperature” of the LLM), the role of the LLM can be modified, the prompt can be modified, etc.

At step 130, the computer-implemented method 100 includes automatically actioning the at least one alert based on the certainty score. Auto actioning can be performed based on determining whether each of the at least one alert represents an actual violation of the predetermined policy. Optionally step 130 can be based on the predetermined policy, or a certainty score determined at step 120, or both. As a non-limiting example, the alert can be auto-closed when the certainty score is above a certain threshold. Alternatively or additionally, the alert can be auto-closed when the certainty score indicates that the alert is a false-positive. In some embodiments, auto-actioning the alert can include preventing the alert from being displayed to a user, or from being triggered. For example, instead of, or in addition to, auto-closing the alert, the method 100 can include determining that the alert should not be displayed to a user. As yet another example, auto-actioning the alert can include escalating the alert for further analysis and/or prioritizing the review of the alert.

It should be understood that “auto-closing” is a non-limiting example of an action that can be taken based on the certainty score.

In some embodiments, the computer-implemented method 100 can also include displaying information about the alert, the policy, the LLM, and/or the certainty score to a user. For example, in some embodiments the computer-implemented method can include displaying both the alert and an analysis of the alert for a user to review. Optionally, the user can input a response approving or rejecting the analysis of the alert. As another example, in some embodiments the alert is based on a communication. As described herein, the communication can be any event with language content (e.g., email, chat, a document, social media, phone call, audio, SMS, and/or video). The computer-implemented method can include displaying the communication with an analysis of the alert based on the communication (e.g., by playing the video or audio, or by illustrating the text).

With reference to FIG. 1B, embodiments of the present disclosure can include computer-implemented methods 150 for automatically actioning alerts by dynamically routing alerts to a plurality of models.

At step 160, the method includes receiving an alert from a conduct surveillance system. As described with reference to FIG. 1B, the alert can represent a violation of a predetermined standard generated by a conduct surveillance system in response to analyzing electronic communications.

At step 170, the method includes dynamically routing the at least one alert to one or more machine learning models.

As described below in example 2, the machine learning models can include both general purpose models (e.g., large language models), as well as fine-tuned models (e.g., large language models that have been fine tuned to perform specialized analysis, and/or specific types of communications). The machine learning models can optionally be configured to identify different types of false positive violations of the predetermined standard (e.g., different types of false positive alerts). For example, the machine learning models can be machine learning models that are fine-tuned and/or prompted to identify true violations of the predetermined standard, and thereby determine that an alert does not include a true violation of the predetermined standard (in other words, that the alert is a false positive).

Dynamically routing the at least one alert can include selecting one or more of the machine learning models that corresponds to an alert type of the alert from the conduct surveillance system. For example, machine learning models can be trained/fine-tuned for any and/or all of the alert types that can be generated by the conduct surveillance system.

At step 180, the method can include analyzing the alert using any combination of, or all of, the machine learning models. As described with reference to FIG. 1A and examples 1 and 2, analyzing the alert can include configuring the model to perform chain of thought reasoning and/or a self-verification process (e.g., using a test-queue to verify model performance, as described in Example 1). Examples 1 and 2, herein, provide examples of how the models can be configured using prompting to control the analysis performed by the models.

At step 190, the method can include automatically actioning the alert based on the analysis of the alert. Again, automatically actioning the alert can include closing the alert or escalating the alert. As described in greater detail in examples 1 and 2, closing and/or auto actioning the alert can include storing and/or displaying the alert for manual review.

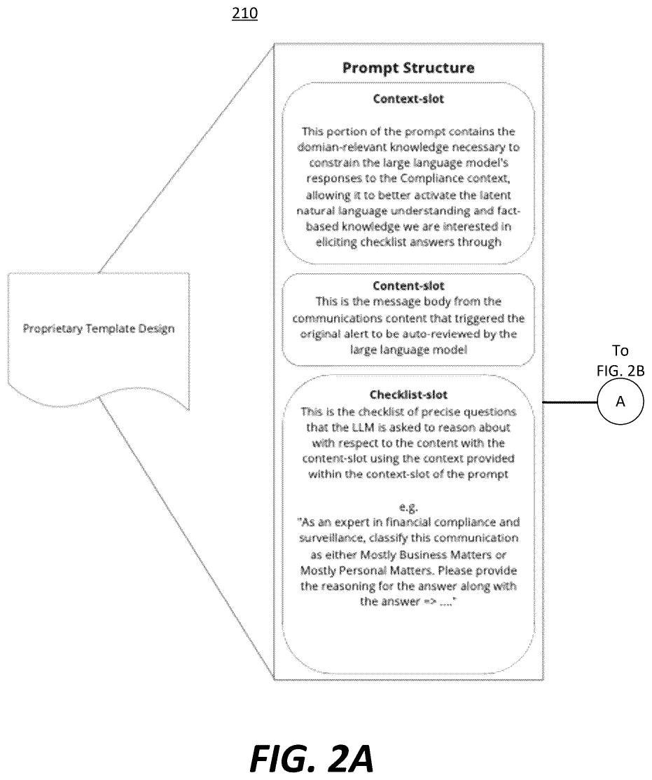

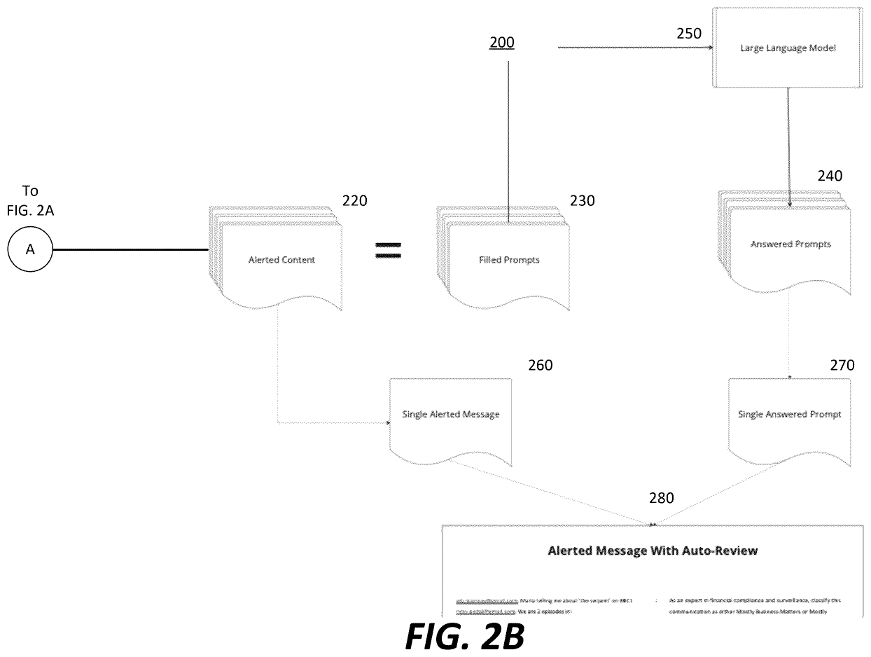

With reference to FIG. 2A and FIG. 2B, an embodiment of the present disclosure include systems for performing automatic review of alerts. In the system 200 illustrated in FIG. 2B, alerted content 220 can be structured using the prompt template 210 illustrated in FIG. 2A. Again with reference to FIG. 2A, a filled (i.e., completed) prompt 230 can be input into an LLM 250. The LLM can create answered prompts 240 based on the filled prompts 230.

The system 200 can be configured to allow a user to review a single answered prompt 270 from the set of answered prompts 240 and a single alerted message 260 from the alerted content 220. The single answered prompt 270 and the single alerted message 260 can be corresponding prompts and messages (e.g., the alerted message that was used to create the filled prompt that the large language model used to create the answered prompt). It should be understood that the message can be any type of communication. The single alerted message 260 and single answered prompt 270 can be displayed as a combined message and prompt 280.

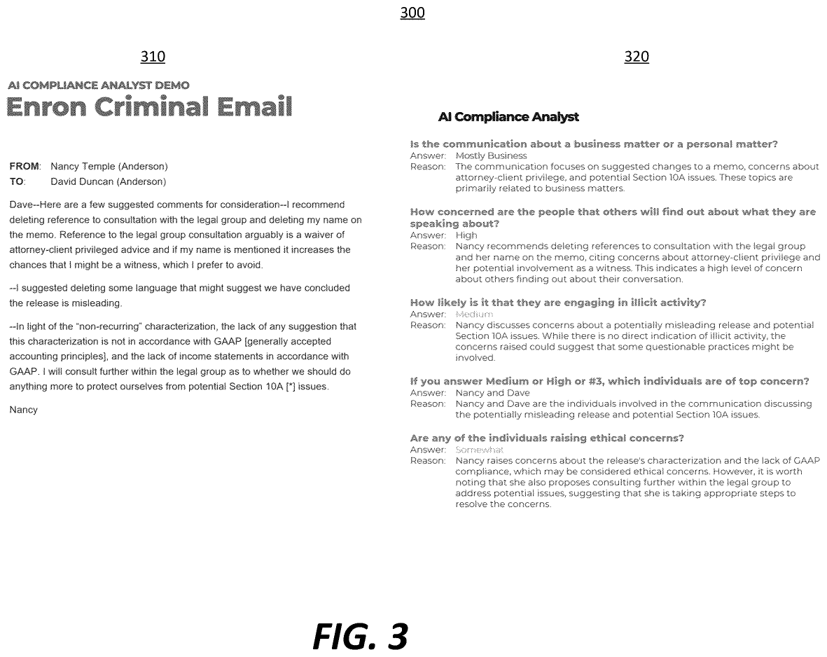

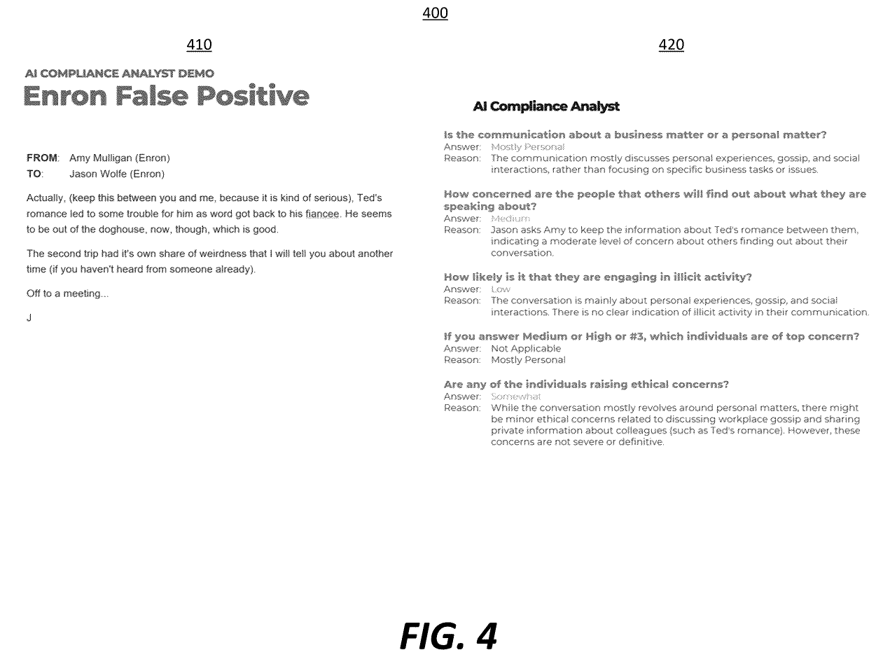

FIG. 3 illustrates an example user interface 300 including an example of a single alerted message 310 with a corresponding answered prompt 320. FIG. 4 illustrates another example user interface 400 including an example of a single alerted message 410 with a corresponding answered prompt 420.

### Example 1

An example embodiment of the present disclosure includes systems and methods to action alerts by auto-closing false positive supervision/surveillance alerts using a generative large language model. While the example embodiment is described using “auto close” as an example, it should be understood that “auto close” is an example action (or an example of “actioning”) for an alert, and that any other action can be taken based on the review performed by the AI language model. An example embodiment described herein can be used to generate explainable auto-closed alerts (e.g., supervision/surveillance alerts) using an LLM.

An example embodiment of the present disclosure can be used with a system that uses scenarios to generate an alert. The alerts can represent risks. In some use cases, alerts are false positives, and false positives can represent a significant proportion of alerts. This can cause a burden on human reviewers to review the alerts, determine the alerts are false positives, and close the alerts. Alternatively or additionally, the alerts can be screened by the systems and methods described herein to identify lower risk, less interesting, or less useful alerts. Optionally these lower risk, less interesting, or less useful alerts can be de-prioritized for human review, or not displayed at all.

LLMs can be used to create alert review systems that include compliance aligned, near human-level reasoning about the materiality of these alerts prior to human review, thereby reducing the volume of alerts that human compliance teams have to manually review.

In some examples described herein, the alerts can be “bulk closed” where the alerts are closed based on context., it is assumed that alerts typically bulk closed, an action that leverages one or more common contextual indicators that were undetected/undetectable by the original scenario, which invalidates the risk relevance of the alert are “low hanging fruit” for emerging general purpose LLMs.

The example embodiment can include a prompt template that can provide some compliance/human-level context about the risk the scenario was designed to detect, and how it maps to relevant regulations, the alerted message content, and one or more checklist-like questions, designed to elucidate the materiality of the message content should be designed.

The checklist questions should be derived either through SME recommendations, that should be validated against relevant data (e.g. bulk closed alerts in BLK), or as direct conceptual rules derived from a suitable tranche of bulk closed messages.

This template can be populated by each message to generate a prompt to be passed to an LLM. Optionally, the LLM is a general purpose LLM (e.g. ChatGPT, GPT4A11). The LLM's described herein can be built using artificial neural networks. The LLMs referred to herein can include millions or billions of weights that can be used to predict a response based on an input. Moreover, the LLM's referred to herein can be used to mimic human reasoning by producing original outputs when applied to inputs that were not used to train the LLM. The template can also direct the LLM to respond to checklist questions in a “show your reasoning” way (also referred to herein as “chain of thought” or “COT” prompting), which can increase the interpretability of the LLMs actions, and reduce the risk that an incorrectly selected or configured model can fail to recognize risks.

“Show your reasoning” is an added benefit that can improve the efficiency with which a human reviewer can either accept or reject the LLM analysis and/or conclusion. The example embodiment can be configured so that the LLM consolidates the facts associated with the corresponding reasoned answers into a concise natural language statement that the human reviewer can validate based on the original alert content itself. Optionally, this can be used to switch the human reviewer's task from difficult deductive reasoning about the communication to less difficult inductive reasoning based on the LLM review. An example of show your reasoning is disclosed herein, where an example communication is analysed using an LLM as a first-line review.

An example of original communication content is provided on the following page.
bob@gmail.com: Maria telling me about ‘the serpent’ on BBC1
sara@gmail.com: We are 2 episodes in!
bob@gmail.com: everyone raving about it
sara@gmail.com: Would recommend
bob@gmail.com: I will catch up tonight
sara@gmail.com: I knew nothing about it at all, but Josh had heard of the story so we decided to watch. All new to me so pretty gripping??
bob@gmail.com: must admit I have never heard of the story??
sara@gmail.com: i think it's better that way
bob@gmail.com: yep I always google stuff straight away
joe@gmail.com: Don't feel like that, you wanted to be there for her, and that is very nice of you
bob@gmail.com: will leave this one alone
sara@gmail.com: only thing you need to know-is one of the actresses is from emmerdale
sara@gmail.com: that's all I googled
bob@gmail.com: jenna coleman
bob@gmail.com: Dr Who??
sara@gmail.com: yeah

Example checklist question: As an expert in financial compliance and surveillance, classify this communication as either Mostly Business Matters or Mostly Personal Matters. Please provide a reasoned explanation of your answer within the context of the communication content=>

### Example LLM Question/Answer

As an expert in financial compliance and surveillance, classify this communication as either Mostly Business Matters or Mostly Personal Matters. Please provide a reasoned explanation of your answer within the context of the communication content=>

Mostly Personal Matters. The communication is discussing a TV show and personal plans to schedule a meeting with friends. There is no mention of any business

Optionally, the LLM prompt template can include a checklist. The prompt template is designed to allow checklist questions to be modified and swapped out as a module or slot within the template. This has the intended benefit of making the template as general purpose as possible, while the content used to populate the template can be as diverse and precisely configurable according to the types of communication alerts being auto-reviewed by the LLM (e.g. different checklist questions are expected to be required for messages from different communications platforms such as email vs chat vs audio etc.).

Optionally, different alert types (e.g. secrecy, rumour, gifts and entertainment) can use different checklist questions to reason about the risk materiality of the alert in question.

Another example embodiment of the present disclosure includes systems and methods for using LLM's to auto-close alerts, and to reason about alerts. This example embodiment can further include systems and methods for validating the performance of LLM's before and during the use of an LLM.

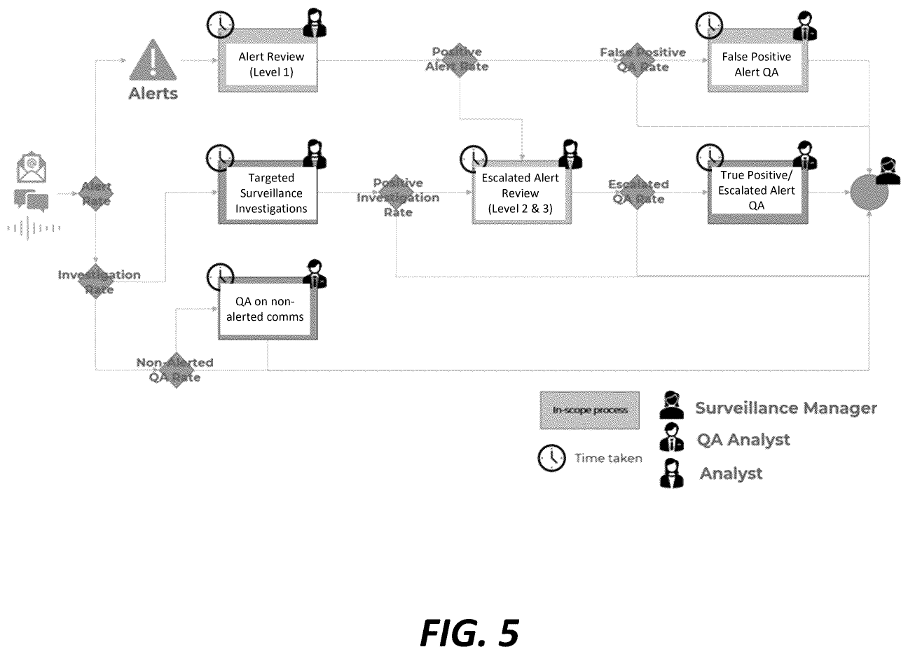

An example communications surveillance and supervision system can be designed to automatically detect risk within in-scope messages. FIG. 5 illustrates an example workflow including an alert system and various human users who use the system to review and action alerts. These systems can automatically triage what are believed to be communications that have a higher probability of risk to compliance teams for manual review. The example communication and surveillance system can perform automatic triage by pattern-matching using dictionaries of terms (lexicons) or machine learning. Even with highly tuned lexicons or effective machine learning models, a significant number of alerts can be produced that will need to be subsequently reviewed. At a large organization, thousands, or millions, of alerts can be generated per year. The process of generating these alerts is referred to in this example as Alert Generation.

Compliance (e.g., Surveillance/Supervision) teams can close alerts that are false positives. Compliance teams can focusing on communications that appear to be riskier after initial review. In the present example of surveillance, this initial review is referred to as a “Level 1 review.” Level 1 review can be performed by large teams that can be relatively inexperienced. Optionally, the supervision of these teams can be structured so that alerts are grouped by smaller populations (e.g., departments, groups of desks at an office, etc.). Alerts that are not closed at the level 1 review stage can be escalated to a more senior reviewer. The more senior reviewer (e.g., a “supervisory principal) can make a final decision as to whether an alert is a false positive, indicates an actual risk, or what action should be taken based on the alert. The level 1 process can be referred to as Alert Management in the present example, and can include computer tools and systems to and normally operates in the system that has generated the Alert.

Level 1 reviews can be simplified, structured and use Standard Operating Procedures. Reviews can be quick, with the aim to remove false positives. Alternatively or additionally, reviews can include screening out lower risk or less useful alerts. The Compliance Analysts use their understanding of natural language, communication structures (i.e. to identify news blasts, duplicates), industry knowledge, and potential risk typologies to make an assessment. User interfaces demand quick close capabilities with easy, and preferably automatic, categorization to ensure this process is as fast as possible. Human level 1 reviewers can operate at around 300-500 Alerts reviewed per day.

A level 1 reviewer can have two high-level decisions to make: escalate to Level 2, or close as a False Positive. Escalation can result in a more detailed analysis of the communication. A Level 2 analyst may combine multiple alerts together, interrogate multiple knowledge bases, and reach out to subject matter experts to determine if there is a policy breach. This process can be referred to as Case Management in the present example, and the Level 2 analyst can be referred to as working on a Case.

Level 1 reviews that mark an Alert as a False Positive can go through a QA process, with closed Alerts sampled to check for incorrectly classified Level 1 reviews (so a False Positive that should have been escalated). This sampling can be stratified, with more inexperience Level 1 Analysts being sampled at a higher rate than a more experienced Analyst. The sampling rate applied to an Analyst will change over time as they become more experienced or if it is found that their reviews are accurate. Optionally no sampling of Level 1 reviews can be performed.

Cases that a Level 2 Analyst determines contain a policy breach can get passed to ‘Level 3’. Level 3 are individuals that can take an action on the breach. In the present example, examples of Level 3 include an HR team, an Employee Compliance team, or another Compliance team (if a STOR, SAR or STR needs to be raised). Often more than one Level 3 team is involved.

The example embodiment can use a Large Language Model and/or additional logic to mimic the Level 1 process that can currently require manual human review. An example LLM was configured to perform as a Level 1 Analyst (the “example LLM bot”). The example LLM bot can optionally be trained using domain specific materials similar to those that would be viewed by a Level 1 analyst. It should be understood that the context of a Level 1 analyst is intended as a non-limiting example, and that other levels of analyst can be performed by embodiments of the present disclosure, and/or the level 1 analyst role can be defined differently in alternative systems or methods. For example, generative AI's according to embodiments of the present disclosure can be used to explaining decision logic in natural language, and so can provide an extensive comment for decisions made on all alerts worked, something that can slow human reviews.

An example human Level 1 Analyst can perform the following routine steps:
1. They perform a quick review of the Alert using Standard Operating Procedures (SOP)
2. They access a limited set of Knowledge Bases.
3. Their work is reviewed by their Manager and/or a QA team.
4. They ask team members if uncertain.

The example embodiment can include standard operating procedures (SOPs) that can be incorporated into the LLM. Compliance Analysts follow SOPs that state the actions they should perform when reviewing an Alert. The example LLM bot can operate in a similar manner, with the exception that each action is in effect a prompt with a yes/no answer with surrounding logic.

### Example Dialogue

Prompt: Is this communication about a Financial Topic? Please explain step-by-step
Example LLM bot: Yes, the communication is discussing a deal involving a major bank.
Prompt: Is this alert in a disclaimer?
Example LLM bot: No, the alert is not in a disclaimer.

It should be understood that the “yes” and “no” questions described in the present disclosure are non-limiting examples. Alternative or additional prompts can prompt the LLM to estimate probabilities or magnitudes, or categorize communications into groups. As a non-limiting example, the prompt can include questions to categorize alerts as “low, medium, or high” risk or any other classification.

The example LLM bot can include a knowledge base. The knowledge base can be used by the example LLM bot to look at previous Alerts and Dispositions involving the same participants to enable it to answer additional questions.

Analysts sometimes do not put quantitative values on their assessment of an Alert. The example LLM bot can operate in a similar manner, with Yes/No/Maybe Answers without a numeric output.

Embodiments of the present disclosure can be configured so that incorrect LLM outputs do not result in false negative results when processing alerts. In some embodiments, the example LLM bot can be setup so that common errors of the example LLM bot do not auto-close Alerts. This means that errors in the example LLM bot do not cause errors where an Alert that should be reviewed by an Analyst gets closed.

### Example Prompts

### Prompt Option 1:

Sentence: “Guess what I have just heard, there is a secret leaving party for John”
Prompt: Is this communication about a Financial Topic? Please explain step-by-step
Hallucinating example LLM bot: Yes, the communication is discussing a financial topic because . . .

The hallucination would not cause the example LLM bot to auto-close the Alert, as it has hallucinated into the risk state (i.e. a financial topic could be risky and needs a human review)

### Prompt Option 2:

Sentence: “Guess what I have just heard, Tractor Inc is buying Shed Inc”
Prompt: Is this communication about a Personal Topic? Please explain step-by-step
Hallucinating example LLM bot: Yes, the communication is about a personal topic because . . .

The error would cause the example LLM bot to auto-close the Alert, as it has failed into the non-risk state (i.e., a financial topic could be risky and needs a human review)

By setting up questions so that the Affirmative answer ‘Yes’ aligns with the Positive class (risk state), an error of the example LLM bot will not incorrectly close Alerts that should be manually reviewed.

Alternatively or additionally, in some embodiments the example LLM bot is configured so that it only auto-closes an Alert if all answers to prompts are answered No (i.e. if any Question has the answer Yes or Maybe, the example LLM bot should not auto-close the Alert). An LLM can be configured using a parameter referred to herein as “temperature” the temperature of the model. The “temperature” can range from “0” (deterministic) to higher values that provide additional variance in responses.

In the present disclosure, some embodiments can have a low or zero temperature to produce deterministic or near-deterministic outputs. Optionally, the example LLM bot is configured to always give the same answer based on the same input, which can correspond to a temperature of 0.

In some embodiments of the present disclosure, the example LLM bot is configured to escalate alerts once the example LLM bot determines a “yes” or “maybe” answer to one of the prompts. The example LLM bot can discontinue asking questions once a prompt is answered affirmatively to save resources.

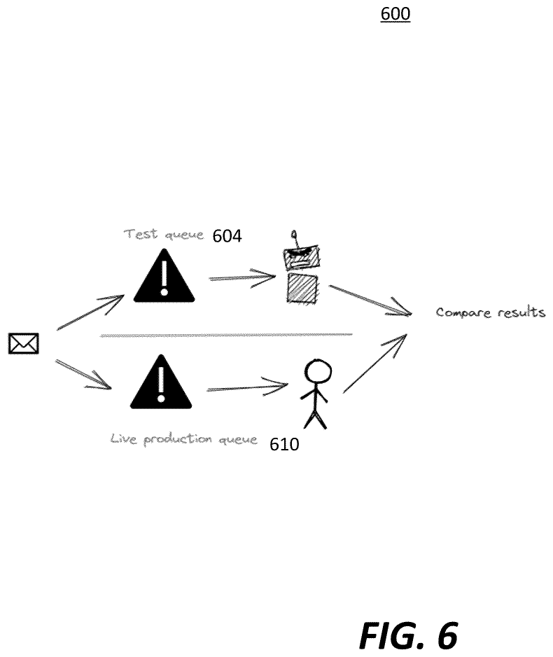

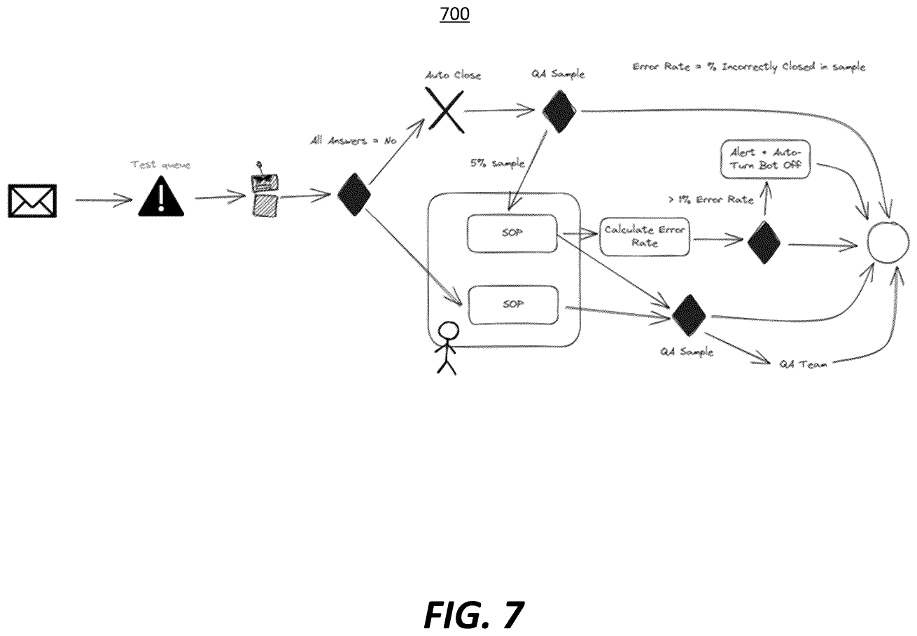

Optionally, the example LLM bot can be tested using a “test queue” that is in parallel to the normal review queue. The test queue can be used to validate the example LLM bot for a specific workflow. FIG. 6 illustrates a comparison 600 of a test queue 604 and live production queue 610. The outputs of both the test queue 604 and live production queue 610 can be compared after a period of time (e.g., 2 weeks) to validate the performance of the example LLM bot in the test queue 604. Optionally the auto-closed alerts of the LLM bot can be randomly sampled and reviewed by a human, to determine whether the review is reliable. FIG. 7 illustrates a flowchart 700 of an example method of determining the error rate of an example embodiment of the present disclosure.

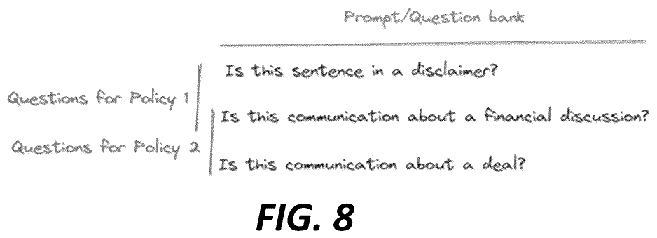

With reference to FIG. 8, embodiments of the present disclosure can include question/prompt banks to configure the LLM bot. An example question/prompt bank can include different questions/prompts organized by policies that the LLM bot is configured to review, as shown in FIG. 8. Users can choose and change which prompts are used when assessing an Alert from a specific Policy/Scenario.

Optionally, the question/prompt can include questions other than “yes” or “no.” For example, in some embodiments the question/prompt can include questions that prompt the LLM bot for levels of certainty (e.g., “high, medium, or low”).

The example LLM bot can be fine-tuned with similar information to a Level 1 Analyst. This can include training the example LLM bot using specialist compliance knowledge. As a non-limiting example, a Surveillance Analyst gains knowledge from the following sources:
A. Background knowledge:
   a. Compliance training->what are the rules
   b. Ex-Trader->how to trade
   c. general financial concepts
B. Example external cases
C. On the job training:
   a. Knowledge from other team members
   b. Reviews by managers
D. Standard Operating Procedures that you follow

The LLM bot can be provided with (A) and (B) as data sources, some of can also optionally be used to train the LLM. (C) can be provided by Knowledge Bases and the quality assurance mechanism as described with reference to the present example. (D) can be provided by the question/answer setup as described herein.

Optionally, the example LLM bot can be configured with a lexicon, scenario, and/or policy to streamline review. For example, the lexicon, scenario and/or policy can be used to perform an initial review and reduce the number of communications reviewed by the example LLM bot.

### Example 2

As described above, conduct surveillance systems can include computerized systems for detecting violations in natural language text using various combinations of lexicons, scenarios, and machine learning models, for example. These systems can automate the process of generating alerts based on unstructured human language data. However, such conduct surveillance systems can also generate large numbers of alerts when applied to natural language data. These alerts can include false positives, where alerts are generated for conduct that does not include violations. As used herein, a “false positive” is in contrast to a “true positive” where the alert represents a true violation of the predetermined standard. In other words, a true positive occurs when the conduct detected violates the predetermined standard.

Multiple levels of human review are commonly employed with conduct surveillance systems. For example, an organization may use a conduct surveillance system to automatically generate alerts, and those alerts can then be reviewed by human reviewers to close false positive alerts and/or escalate the alerts to a second level of human review for action and/or further analysis. Alternatively or additionally, human reviewers can be organized by subject matter, and additional levels of human review can be employed. Thus, the automated conduct surveillance system can require significant labor to implement, where every alert can require one or more levels of human review.

In some applications, the most common type of alert generated by a conduct surveillance system can be a false positive alert, where the alert indicates the presence of a violation when no actual violation has occurred. In existing systems, the alerts can be sent to human “Level 1” or “Ll” reviewers that manually reviews the alerts and determines whether the alert is a false positive. As part of the manual review, the human reviewer can be required to complete a checklist or other documentation explaining why the alert was a false positive. The human reviewer can also decide to close the alert. This process can be highly time consuming and/or prone to human error.

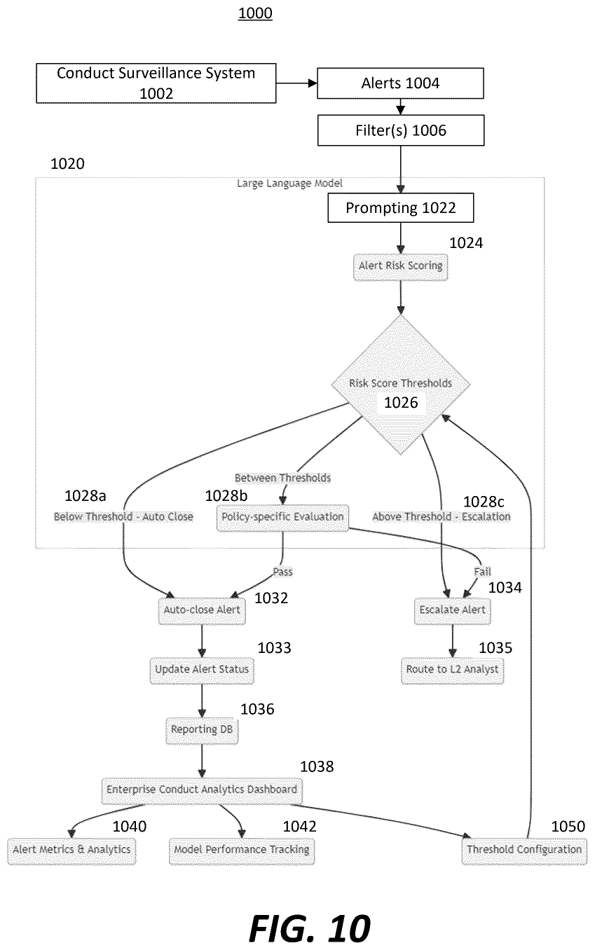

With reference to FIG. 10, an example embodiment includes a system 1000 configured to for automating conduct review and surveillance workflows. In particular, the example embodiment includes automated reviews of alerts generated by conduct surveillance systems 1002. The automated reviews described herein can include both evaluating the alert (e.g., determining a risk score for the alert), and/or determining an action that should be taken on the alert (e.g., escalating or closing the alert). The example embodiment can further optionally action the alert by transmitting the alert to additional conduct surveillance systems (e.g., other machine learning systems), and/or display the alert to a user for further analysis and review. As used herein, the “risk score” can represent either a numeric score (e.g., between 0 and 100) and/or a category (e.g., low, medium, and high). The risk score can represent the probability that the communication associated with the alert is a true positive (i.e., that the communication is a violation), and/or that it is a false positive. It should be understood therefore that the numbers and scores described herein are only non-limiting examples The conduct surveillance system 1002 generates alerts 1004, as described above. The alerts 1004 are input into a large language model 1020. It should be understood that the alerts 1004 input into the large language model 1020 can include the associated communication data that triggered the alert. For example, when the conduct surveillance system 1002 outputs an alert 1004, and the alert 1004 is based on an email that is the message/communication, the alert 1004 input into the large language model 1020 can include part or all of the email text. Alternatively or additionally, the alert 1004 can further include metadata for the message/communication that triggered the alert, information about the scenario/model of the conduct surveillance system 1002 that triggered the alert 1004, business risk of the alert 1004, and/or compliance violation associated with the alert 1004.

Optionally, the alerts 1004 can be filtered by one or more filters 1006 before being input into the large language model 1020. The filters 1006 can include one or more rules used to eliminate false positives. For example, filters 1006 can exclude alerts 1004 that correspond to communications with large numbers of participants (e.g., greater than 20), communications including marketing materials, and/or communications including disclaimers, etc. Communications that are filtered by the filters 1006 may not be input into the large language model 1020.

Inputting the alerts 1004 into the large language model 1020 can optionally include “prompting” the large language model 1020 to evaluate the alert 1004 and output a risk score 1024 for the alert 1004. Optionally, prompting 1022 can include inputting the alert 1004 and/or the communication that triggered the alert 1004 into the large language model 1020 with a query configured to cause the large language model 1020 to output a score for the alert. Prompting 1022 can include the use of multiple prompts (e.g., a series of prompts). For example, one or more prompts can be configured to determine risk scores corresponding to each policy for the alert. Optionally, the prompts can include questions that are assigned risk scores based on their relevance to specific compliance policies. The risk scores 1024 corresponding to each policy can then be used to determine an overall risk score 1024 for the alert 1004. In the example embodiment, larger “risk scores” (e.g., larger numeric values) correspond to higher risk alerts (e.g., alerts that are more likely to be true positives, and less likely to be false positives).

Alternatively or additionally, the prompts used can be prompts that are configured to generate explainable outputs. The explainable outputs can be stored in the database 1036 described in greater detail below. For example, the prompts can be configured to cause the large language model 1020 to output explanations associated with the risk scores. An example explanation includes an attention analysis, where the large language model indicates where the large language model 1020 is configured to identify which input data (e.g., the communication and/or alert) is being relied on for the analysis, and thereby explain the decisions of the large language model 1020.

As another example of prompting 1022, the prompts can include a series of questions where each of the questions are assigned risk scores based on their relevance to the specific compliance policy. The risk score, ranging from 0-100, represents the probability that the alert contains a true compliance violation.

In some implementations, the large language model 1020 can include multiple large language models. The multiple large language models can include any combination of pre-trained (e.g., general purpose) large language models and fine-tuned large language models (e.g., large language models that have been fine-tuned using datasets related to compliance, sentiment analysis, etc.). Optionally, the large language models can include large language models fine-tuned for specific risk classes (e.g., quid-pro-quo, hate speech, anti-money laundering, rumor, etc.) Optionally, the multiple large language models can be configured to risk scores to different types of risk, for example by prompting each large language model of the large language models to output risk scores. For example, a general-purpose large language model can be prompted to output an overall risk, and/or categorize the alert. Fine-tuned large language models can be prompted to assign risk scores for specific conduct types.

As a non-limiting example, the risk scores for different types of conduct can be combined by weighting and/or aggregating them into a normalized risk score (e.g., 0-100). A non-limiting example calculation of risk score is:
Risk Score=Σ(Wᵢ×Pᵢ)×100
   where:
      Wᵢ=Weight assigned to risk class
      Pᵢ=LLM output probability for risk class

The weights can optionally be adjusted based on the relative importance and historical prevalence of different risk types. Additionally, the weights can be configured based on user inputs (e.g., by the dashboard 1038 described below).

The risk score(s) 1024 can be compared to risk score thresholds 1026 to automatically process the alerts 1004. The risk score thresholds 1026 can include predetermined risk scores and/or ranges of scores that correspond to predetermined levels of risk. Optionally, the predetermined risk scores can be input by a user, or configured by a user.

In the example embodiment shown in FIG. 10, a first threshold is set as a lower threshold, and a second threshold that is greater than the first threshold. Therefore at least three ranges are defined in the example embodiment by the values below the first threshold, those between the first threshold and second threshold, and those above the second threshold. It should be understood that the thresholds and ranges described herein can be inclusive or exclusive, for example, the first threshold can optionally include only the values below the first threshold, and/or values including the first threshold, etc. When the risk score 1024 of the alert 1004 indicates that the alert is a false positive (e.g., the risk score of the alert 1004 is below the first threshold at step 1028a), the alert 1004 can be auto-closed at step 1032.

As non-limiting examples, when the risk score 1024 is measured from 0-100, a first threshold can be 20-30 and a second threshold can be 80-90. Alternatively or additionally, alerts below the first threshold can be referred to as “low risk,” alerts between the first threshold and second threshold can be referred to as “medium risk” and alerts above the second threshold can be referred to as “high risk.”

When the risk score 1024 of the alert 1004 is between the first threshold and second threshold, a policy-specific evaluation can be performed at 1028b. The policy-specific evaluation can optionally include any or all of the following, alone or in combination:
1. Contextual Analysis: Evaluating the context in which the communication occurred. For example, if the communication is part of a larger email thread, the system can assess the overall tone and content of the entire thread rather than just the individual message.
2. Communication Patterns: Analyzing patterns in communication behavior, such as frequency of interactions between certain individuals, timing of messages, or sudden changes in communication style, which can indicate potential compliance issues.
3. Historical Data Comparison: Comparing the current alert with historical data to identify similarities with past incidents that were escalated or resolved as false positives. This can be used to make decisions based on past outcomes.
4. Behavioral Indicators: Considering behavioral indicators such as the sentiment of the communication, use of evasive language, or indications of urgency, which might elevate the risk score of the alert.
5. User Roles and Permissions: Taking into account the roles and permissions of the individuals involved in the communication. Alerts involving high-risk roles (e.g. traders, investment bankers) can have a stricter criteria.

The output of the policy-specific evaluation performed at 1028b can be used to determine whether to escalate at step 1034 or auto-close the alert 1004 at step 1032. If the policy-specific evaluation at 1028b indicates that the alert 1004 is not high risk, then the alert can be auto-closed at step 1032. If the policy-specific evaluation indicates that the alert is high risk, then the alert can be escalated at step 1034.

When the risk score 1024 of the alert 1004 is above the second risk score threshold at 1028c, the alert can be escalated at step 1034. Optionally, when the alert is escalated 1034 it can be routed at step 1035 to a human review. Optionally, routing at step 1035 can include transmitting and/or displaying the alert to the human reviewer.

Still with reference to FIG. 10, the present disclosure contemplates that the system can be configured to document and/or log the outputs of the large language model 1020. In the example embodiment of FIG. 10, at step 1033 the alert status can be updated, for example by updating the status of the alert from an open status (indicating that the alert requires review) to a closed status (indicating that the alert has been reviewed. The auto-closed alert 1004 from step 1032 can be input and/or transmitted to a reporting database 1036. The reporting database 1036 can optionally store any or all of the outputs of the large language model 1020 (e.g., the natural-language responses of the large language model 1020 to the prompting 1022, and/or any of the associated risk scores 1024.

Optionally, the reporting database 1036 can be configured to output data to a reporting dashboard 1038. The reporting dashboard 1038 is configured to display data to a user and used to configure the large language model 1020. For example, the reporting dashboard 1038 can be used to configure the risk score thresholds 1026, by changing the values of the risk score thresholds at step 1050. As described above, the risk score thresholds 1026 can optionally be configured by the user on a per-policy basis, so that, for example, alerts corresponding to different policies can be auto-closed based on different risk thresholds.

The dashboard 1038 can further be configured to display alert metrics and analytics 1040. The dashboard 1038 can further be configured to track the performance of the conduct surveillance system 1002 based on the auto-closed alerts and escalated alerts and output model performance tracking information 1042. Non-limiting examples of alert metrics and analytics 1040 that can be displayed include alert rate, escalation rate, false positives, total alert trends, auto-closure rate (percentage of alerts automatically closed by the system); escalation rate (percentage of alerts escalated by the system); accuracy (precision and or recall of the system); and/or efficiency gain (hours of labor saved by the system). As used herein, precision refers to the number of true positives divided by the sum of the true positives and false positives. As used herein, recall refers to the number of true positives divided by the number of true positives and false negatives. Alternatively or additionally, the escalation rate can be computed as the number of auto-closures that are overturned by a subsequent manual review, divided by the number of total auto-closures. As yet another example, the alert metrics and analytics can include a model confidence score including a statistical measure of how certain and/or confident the large language model 1020 or models are about the auto-closure of each alert.

The metrics and analytics 1040 can be from any time period (e.g., any day, week, month or other period). The metrics and analytics 1040 can be computed and/or displayed as rates and/or percentages, for example. It should also be understood that the reporting database 1036 can optionally include information from the escalated alerts at step 1034 and/or data from the manual review completed at step 1035.

In some embodiments, the dashboard 1038 can be configured to sort alerts and/or the corresponding communications that generated the alert 1004. For example, the dashboard 1038 can display the alerts and/or corresponding communications in order of risk score, and/or by the type of alert with a risk score above the threshold. Optionally, the dashboard 1038 can configure the system so that alerts are not auto-closed at step 1032. Optionally, when alerts are not auto-closed at step 1032, any or all of the other alert steps can be performed.

In some embodiments, the dashboard 1038 can be configured for the modification/editing of the outputs of the large language model 1020. For example, the dashboard 1038 can be configured so that a user can manually edit any and/or all of the risk scores output by the large language model 1020, as well as any/all of the explanations output by the large language model 1020. The dashboard 1038 can further be configured to log any/all of the edits performed by the dashboard so that the Optionally, edits performed using the dashboard 1038 can be used as inputs to training and/or fine-tuning the large language model 1020 and/or configuring the prompting 1022 of the large language model 1020. Optionally, training, fine tuning, and/or prompt configuration can be performed at any predetermined interval (e.g., monthly, weekly, etc.)

It should be understood that, in some embodiments of the present disclosure, the policy-specific analysis may not be performed. For example, a single risk score threshold 1026 can be used, and alerts with risk scores above that risk score threshold can be escalated, while alerts with risk scores below that risk score threshold 1026 can be auto-closed.

In some embodiments, the large language model 1020 can be configured to perform additional analysis for alerts based on the risk score thresholds 1026. For example, if the alert is above the threshold at step 1028c, the large language model 1020 can be configured to output a detailed explanation with reasoning for the corresponding alert (e.g., by prompting). That explanation can be output/stored at the database 1036. Optionally, the dashboard 1038 can be further configured to display/output the explanation(s) stored at database 1036 for further review.

Additional description of prompting, including example prompts that can be used, is provided in Example 1.

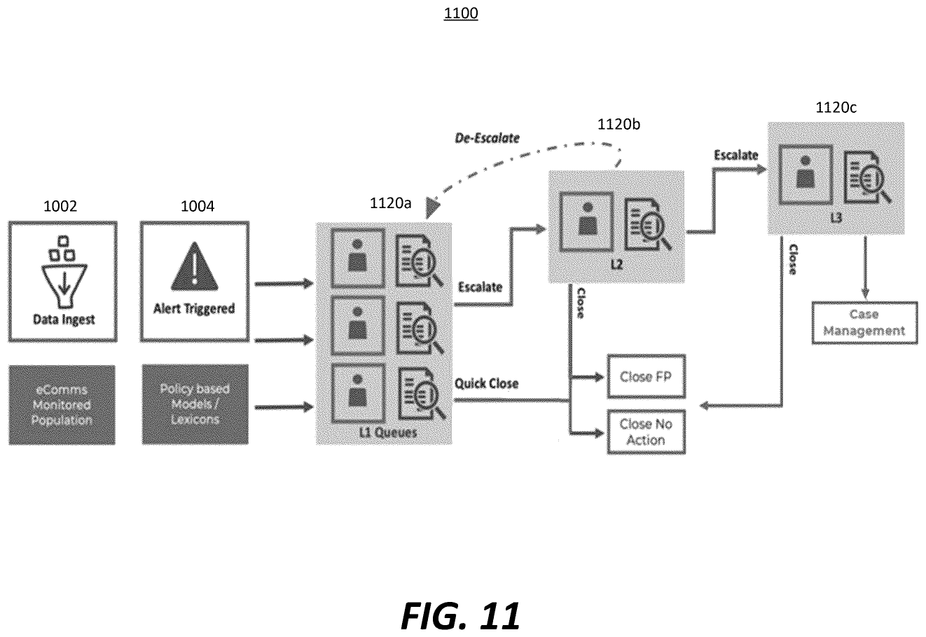

It should be understood that embodiments of the present disclosure can be used with systems having different workflows. For example, FIG. 11 illustrates a system 1100 for reviewing alerts 1004 from a conduct surveillance system 1002, where the system 1100 includes three levels of review, 1120a, 1120b, 1120c. It should be understood that any number of levels of review can be used in embodiments of the present disclosure, and that embodiments of the present disclosure can be used at different levels of review to improve the effectiveness and/or efficiency of any of the levels of review 1120a, 1120b, 1120c. For example, while the example embodiment described with reference to FIG. 10 is configured to perform the first level of review, 1120a, it could also be used to perform other levels of review (e.g., 1120b and 1120c) in embodiments of the present disclosure.

### Example Computing System Architecture

FIG. 9 is a computer architecture diagram showing a general computing system capable of implementing one or more embodiments of the present disclosure described herein. A computer may be configured to perform one or more functions associated with embodiments illustrated in, and described with respect to, one or more of FIGS. 1A-8, 10, and 11. It should be appreciated that the computer may be implemented within a single computing device or a computing system formed with multiple connected computing devices. For example, the computer may be configured for a server computer, desktop computer, laptop computer, or mobile computing device such as a smartphone or tablet computer, or the computer may be configured to perform various distributed computing tasks, which may distribute processing and/or storage resources among the multiple devices.

As shown, the computer includes a processing unit, a system memory, and a system bus that couples the memory to the processing unit. The computer further includes a mass storage device for storing program modules. The program modules may include modules executable to perform one or more functions associated with embodiments illustrated in, and described with respect to, one or more of FIGS. 1A-8, 10, and 11. The mass storage device further includes a data store.

The mass storage device is connected to the processing unit through a mass storage controller (not shown) connected to the bus. The mass storage device and its associated computer storage media provide non-volatile storage for the computer. By way of example, and not limitation, computer-readable storage media (also referred to herein as “computer-readable storage medium” or “computer-storage media” or “computer-storage medium”) may include volatile and non-volatile, removable and non-removable media implemented in any method or technology for storage of information such as computer-storage instructions, data structures, program modules, or other data. For example, computer-readable storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer. Computer-readable storage media as described herein does not include transitory signals.

According to various embodiments, the computer may operate in a networked environment using connections to other local or remote computers through a network via a network interface unit connected to the bus. The network interface unit may facilitate connection of the computing device inputs and outputs to one or more suitable networks and/or connections such as a local area network (LAN), a wide area network (WAN), the Internet, a cellular network, a radio frequency network, a Bluetooth-enabled network, a Wi-Fi enabled network, a satellite-based network, or other wired and/or wireless networks for communication with external devices and/or systems.

The computer may also include an input/output controller for receiving and processing input from a number of input devices. Input devices may include, but are not limited to, keyboards, mice, stylus, touchscreens, microphones, audio capturing devices, or image/video capturing devices. An end user may utilize such input devices to interact with a user interface, for example a graphical user interface on one or more display devices (e.g., computer screens), for managing various functions performed by the computer, and the input/output controller may be configured to manage output to one or more display devices for visually representing data.

The bus may enable the processing unit to read code and/or data to/from the mass storage device or other computer-storage media. The computer-storage media may represent apparatus in the form of storage elements that are implemented using any suitable technology, including but not limited to semiconductors, magnetic materials, optics, or the like. The program modules may include software instructions that, when loaded into the processing unit and executed, cause the computer to provide functions associated with embodiments illustrated in, and described with respect to, one or more of FIGS. 1A-8, 10, and 11. The program modules may also provide various tools or techniques by which the computer may participate within the overall systems or operating environments using the components, flows, and data structures discussed throughout this description. In general, the program module may, when loaded into the processing unit and executed, transform the processing unit and the overall computer from a general-purpose computing system into a special-purpose computing system.

### CONCLUSION

The various example embodiments described above are provided by way of illustration only and should not be construed to limit the scope of the present disclosure. Those skilled in the art will readily recognize various modifications and changes that may be made to the present disclosure without following the example embodiments and applications illustrated and described herein, and without departing from the true spirit and scope of the present disclosure.

What is claimed:

1. A computer-implemented method, comprising:
receiving at least one alert from a conduct surveillance system, wherein the at least one alert represents a potential violation of a predetermined standard and wherein the conduct surveillance system generates alerts in response to analyzing electronic communications between persons;
prompting a trained large language model (LLM) to generate an analysis of the at least one alert, wherein the analysis of the at least one alert comprises an explanation and a certainty score; and
automatically actioning the at least one alert based on the certainty score.

2. The computer-implemented method of claim 1, wherein the explanation comprises one or more factors considered during the analysis and reasoning associated with the analysis.

3. The computer-implemented method of claim 1, wherein the trained large language model is configured to use at least one of: chain of thought (CoT) reasoning or self-verification process to generate the analysis of the at least one alert.

4. The computer-implemented method of claim 1, wherein the at least one alert is based on a communication, and the computer-implemented method further comprises displaying the communication and the analysis of the at least one alert.

5. The computer-implemented method of claim 1, further comprising applying a filter to the at least one alert before prompting the trained large language model to generate the analysis of the at least one alert, the filter being configured to identify and disregard obvious false positive violations of the predetermined standard.

6. The computer-implemented method of claim 1, wherein the certainty score represents a probability of the at least one alert represents a true violation of the predetermined standard.

7. The computer-implemented method of claim 1, wherein automatically actioning the at least one alert comprises comparing the certainty score to one or more thresholds and adjusting the one or more thresholds based on user input.

8. A system, comprising:
at least one processor;
at least one memory storing computer readable instructions configured to cause the at least one processor to perform functions for creating and/or evaluating models, scenarios, lexicons, and/or policies with large language models (LLMs), wherein the functions include:
receiving at least one alert from a conduct surveillance system, wherein the at least one alert represents a potential violation of a predetermined standard and wherein the conduct surveillance system generates alerts in response to analyzing electronic communications between persons;
prompting a trained large language model (LLM) to generate an analysis of the at least one alert, wherein the analysis of the at least one alert comprises an explanation and a certainty score; and
automatically actioning the at least one alert based on the certainty score.

9. The system of claim 8, wherein the explanation comprises one or more factors considered during the analysis and reasoning associated with the analysis.

10. The system of claim 8, wherein the trained large language model is configured to use chain of thought (CoT) reasoning to generate the analysis of the at least one alert.

11. The system of claim 8, wherein the functions further comprise displaying the at least one alert and the analysis of the at least one alert.

12. The system of claim 8, wherein the at least one alert is based on a communication, and the functions further comprise displaying the communication and the analysis of the at least one alert.

13. The system of claim 8, wherein prompting the trained large language model comprises inputting a prompt using a prompting language.

14. The system of claim 8, wherein prompting the trained large language model comprises inputting a role prompt.

15. A non-transitory computer-readable medium storing instructions that, when executed by at least one processor of a computer, perform functions that include:
receiving at least one alert from a conduct surveillance system, wherein the at least one alert represents a potential violation of a predetermined standard and wherein the conduct surveillance system generates alerts in response to analyzing electronic communications between persons;
prompting a trained large language model (LLM) to generate an analysis of the at least one alert, wherein the analysis of the at least one alert comprises an explanation and a certainty score; and
automatically actioning the at least one alert based on the certainty score.

16. The non-transitory computer-readable medium of claim 15, wherein the trained large language model is configured to use self-verification process to generate the analysis of the at least one alert.

17. The non-transitory computer-readable medium of claim 15, wherein the functions further comprise applying a filter to the at least one alert before prompting the trained large language model to generate the analysis of the at least one alert, the filter being configured to identify and disregard obvious false positive violations of the predetermined standard.

18. The non-transitory computer-readable medium of claim 15, wherein the certainty score represents a probability of the at least one alert represents a true violation of the predetermined standard.

19. The non-transitory computer-readable medium of claim 15, wherein automatically actioning the at least one alert comprises comparing the certainty score to one or more thresholds.

20. The non-transitory computer-readable medium of claim 15, wherein automatically actioning the at least one alert comprises closing the at least one alert or escalating the at least one alert for further analysis.
